(19) United States
(12) Patent Application Publication
(10) Pub. No.: US 2021/0037723 A1
(43) Pub. Date: Feb. 11, 2021

(54) PLANT HEALTH WITH IN SITU FORMED WATER ABSORBING HYDROGELS

(71) Applicant: Bayer CropScience LP, St. Louis, MO (US)

(72) Inventors: Chenxi ZHANG, Apex, NC (US); Aileen SHIEH, Raleigh, NC (US); James M. RUTLEDGE, Durham, NC (US); Krishnan PALANICHAMY, Cary, NC (US)

(21) Appl. No.: 16/986,745

(22) Filed: Aug. 6, 2020

Related U.S. Application Data
(60) Provisional application No. 62/883,888, filed on Aug. 7, 2019.

(51) Int. Cl. A01G 24/35; B01J 20/26; B01J 20/28; C09K 17/18; A01G 20/00

(52) U.S. Cl. CPC A01G 24/35; B01J 20/267; B01J 20/262; A01G 20/00; B01J 20/28047; C09K 17/18; B01J 20/264

(57) ABSTRACT

Hydrogel-forming components may be applied to soil in dry or wet formulations. After migrating to a targeted area, such as a root zone of a plant, particularly turfgrass, and after a triggering event such as a change in concentration, the hydrogel-forming components form a hydrogel in situ in the targeted area. The compositions and methods of the disclosure advantageously allow for direct application of hydrogel-forming components using existing equipment (such as, for example, sprayers) without tilling or disrupting the plants to which the compositions are applied. Hydrogel-forming components comprise one or more backbones, one or more crosslinkers, and, optionally, one or more adjuvants.

### CROSS REFERENCE TO RELATED APPLICATIONS

This application claims the benefit of U.S. Provisional Application Ser. No. 62/883,888, filed 7 Aug. 2019, the contents of which are herein incorporated by reference in their entirety.

### FIELD OF THE INVENTION

This disclosure relates to methods and compositions relating to soil additives and, in particular, to soil-mobile polymer forming components which can be delivered into rootzones via traditional spraying equipment, resulting in in situ formation of soil-immobile hydrogel polymers. In the compositions and methods of this disclosure, a hydrogel polymer of interest can be delivered to a below-ground target zone without disrupting the surface.

### BACKGROUND OF THE INVENTION

Retaining sufficient plant-available soil water to satisfy plant demand is a challenging task under high evapotranspiration (ET, or vapor pressure deficit) conditions (e.g., warm and dry, or other high-vapor pressure deficit conditions) or with reduced water and labor input. This is especially true for intensively managed perennial or annual plant systems that have little tolerance for foliar wilting, particularly for fine-cut turfgrasses for which shallow rooting is prevalent and wilting is typically not tolerated. Laborious field scouting and repeated hand watering are standard practice to overcome wilting, replenish depleting rootzone moisture, and prevent formation of localized dry spot (LDS) caused by soil hydrophobicity. This is particular true under warm and dry environmental conditions or with reduced water and labor input. On a managed golf course, for example, such conditions are prevalent for at least 3-4 months of the year. Meanwhile, wilting and soil drying may result in soil hydrophobicity, and therefore such conditions need further correction before affected areas can be effectively rewetted.

One attempt in the industry to solve the problem of depleting rootzone moisture is repeated application of soil surfactant (also known as wetting agent with minor distinction) during vulnerable periods of the year. While soil surfactant applications provide some benefits, they mainly serve to correct soil hydrophobicity within the rootzone, thus promoting more uniform soil wetting during irrigation events. However, despite product claims, soil surfactants do not affect soil water-holding capacity. Indeed, soil surfactants may reduce plant-available soil water in the upper rootzone by funneling water deeper into the soil profile. Therefore, equivalent, or even more frequent, field scouting and hand-watering are needed to prevent wilting.

Incorporating super-absorber polymers (SAPs) may improve plant-available soil water, improve health, and reduce yield loss under drought conditions by retaining additional soil moisture in the rootzone. SAPs have cross-linked polymer network structures, which can hold water several to a few hundred times the original SAP volume. SAPs include, for example, hydrolysis products of starch-acrylonitrile graft polymers, carboxymethylcellulose, cross-linked polyacrylates, cross-linked polyacrylamides, polyvinyl alcohols, polyacrylonitrile and polyethylene oxide.

There are commercial SAPs designed for annual cropping system use (i.e., physical rootzone incorporation before or at planting). In such use, SAPs are applied as soil additives and are typically buried, manually or mechanically, within the vicinity of root zone. As such, these SAPs can swell and hold water when irrigation water is applied, and later release the water during the irrigation interval or a dry period. Burying of SAPs can typically be accomplished by temporarily removing any plants from the soil, typically done through a gardening-type application. However, drawbacks with large scale undertakings such as widespread turf and in-ground crop applications are obvious, as it is generally impractical or financially infeasible to remove all or most plants and/or top layers of soil. Further, there is a relatively high cost associated with such applications as large amounts of SAPs are generally needed to achieve sufficient performance.

While soil incorporation of water-storing amendments such as SAPs proves valuable in addressing the need to satisfy plant demand, it is rather a narrow-fitted solution for systems in which soil incorporation is feasible and associated disruption is acceptable. And it is not adaptable for plant systems in which soil incorporation and surface disruption are not options. That is, the till-in application method of SAPs typically does not fit, for example, a perennial system such as managed turfgrass, which cannot tolerate such surface disruption.

Some have tried to address these drawbacks by implementing devices for injecting SAPs in situ. For example, some have used modified or standard tilling machines, water-jet injectors, seed drills and coring machines in an attempt to inject polymers into the soil. However, such methods have proved problematic. These previously described methods can disturb topsoil and shock and destroy plants or turf. As such, these methods are largely unsuitable and require SAP insertion before the turf and/or plants have been laid, planted or grown. In addition, these previously described methods often do not distribute the polymers evenly or efficiently, or in the areas that need SAPs the most. This is compounded by the fact that, historically, suitable polymers can be relatively expensive and previously described applications cannot apply them in a cost-effective manner. Finally, such methods do not fit a perennial system such as managed turfgrass, which, as previously discussed, cannot tolerate the disruption resulting from physical rootzone incorporation, whether by mechanical burying or by injection (which often requires SAP insertion before turf and/or plants have been laid, planted, or grown).

Accordingly, there is a need for a solution to deliver a biodegradable hydrogel polymer that improves soil water retention and prevents hydrophobicity into a perennial rootzone without physically disrupting its surface or its existing root system.

### SUMMARY OF THE INVENTION

According to the present disclosure, a solution to solve the problem of depleting rootzone moisture is to deliver sprayable or spreadable plant-safe hydrogel-forming components (i.e., a “backbone” and a “cross-linker”), optionally in combination with other adjuvants (such as, for example, one or more biocides and/or surfactants), via conventional application equipment to a soil profile below the surface. In an embodiment, the components are surface- or foliar-applied via conventional equipment and then carried into the soil profile by post-application irrigation or rainfall. An in-situ hydrogel-forming reaction is triggered by certain physical or chemical processes occurring where the delivered hydrogel-forming components are located. In an embodiment, an example of a triggering event is an increase in component concentration as a result of natural evaporation of soil moisture.

In another embodiment, the components are delivered without the use of conventional application equipment. For example, the components can be delivered directly into the soil profile with minimal surface disruption.

A hydrogel, in the context of the present disclosure, is understood to include, for example, crosslinked hydrophilic polymers, polymers of (co)polymerized hydrophilic monomers, graft (co)polymers of one or more hydrophilic monomers on a suitable graft base, crosslinked cellulose ethers or starch ethers, crosslinked carboxymethyl-cellulose, partly crosslinked polyalkylene oxide or natural products swellable in aqueous liquids, for example guar derivatives. Further examples of such hydrophilic polymers and monomers are described in U.S. 2010/0050506, which is incorporated by reference in its entirety. For purposes of the present disclosure, anything that can function as a hydrogel is within the scope of the disclosure.

On one hand, a hydrogel polymer is a very different type of chemistry from surfactants or wetting agents. By introducing an optimal amount of hydrogel into the rootzone according to the vegetation type, the hydrogel helps retain plant-available soil water during irrigation and/or rainfall events and resist evaporative and leaching loss of soil moisture afterwards. As a result, such treated rootzone soil supports normal plant function under high evapotranspiration conditions for a longer period of time and delays wilting before the next water input events. Additional benefits of hydrogels include, for example, resisting non-plant route water loss in turf use.

On the other hand, hydrogel polymers and SAPs have been utilized in annual cropping systems to improve soil water holding capacity. However, traditional applications require physical incorporation of the soil-immobile polymers into rootzones. The surface interruption resulting from these incorporation procedures is not acceptable in perennial systems like managed turf.

Methods of the present disclosure, however, deliver soil-mobile components into the rootzone via traditional spraying equipment, and subsequently have soil-immobile hydrogel polymers formed in situ. As a result, a hydrogel polymer is delivered to a below-ground target zone without disrupting the surface.

In an embodiment, a soil surfactant is incorporated into the composition of the disclosure to address soil hydrophobicity. When incorporated into the hydrogel polymer composition of the disclosure, an application dose may be optimized so the combined composition may re-wet hydrophobic pockets within the soil and also allow the formulation components to stay within the rootzone of the soil. As a result, the final formulation addresses both soil water retention and soil hydrophobicity activities at the same time.

Formed hydrogels are soil-immobile and difficult to deposit into perennial rootzone. However, if the forming components are plant-safe and soil-mobile, it is possible to effectively deposit them into targeted perennial rootzones with conventional equipment (e.g., sprayers), allowing hydrogels to be formed in-situ with subsequent reaction in the rootzone. This innovative approach allows placement of soil-immobile products (e.g., hydrogels) in the rootzone without disrupting the perennial surface. This concept was supported by proof-of-concept trials in a laboratory, controlled environment and field trials, and has potential to be developed into an innovative and differentiated water management tool addressing customer needs. In an embodiment, a target of the compositions and methods of the disclosure is intensively managed golf turf.

The present disclosure is directed to compositions and processes for improving retention of plant-available soil water.

According to the disclosure, a process for improving retention of plant-available soil water comprises, consists essentially of, or consists of:

a. applying a composition comprising hydrogel-forming components to a soil surface or an above-soil plant part and b. watering the soil surface or above-soil plant part, wherein, after (b), the hydrogel-forming components form a hydrogel in situ in a targeted area, optionally a root zone of a plant.

Hydrogel-forming components according to the disclosure may also be applied stepwise. According to the disclosure, a process for improving retention of plant-available soil water may also comprise, consist essentially of, or consist of:
a. applying a first hydrogel-forming component to a soil surface or an above-soil plant part,
b. applying a second hydrogel-forming component to a soil surface or an above-soil plant part,
c. optionally applying one or more additional components to a soil surface or to an above-soil plant part, and
d. watering the soil surface or above-soil plant part,
   wherein the first and second hydrogel-forming components independently comprise, consist essentially of, or consist of one or more backbone moieties or one or more crosslinking moieties,
   wherein, if the first hydrogel-forming component comprises, consists essentially of, or consists of one or more backbone moieties, the second hydrogel-forming component comprises, consists essentially of, or consists of one or more crosslinking moieties,
   wherein, if the first hydrogel-forming component comprises, consists essentially of, or consists of one or more crosslinking moieties, the second hydrogel-forming component comprises, consists essentially of, or consists of one or more backbone moieties, and
   wherein steps (a)-(d) may be performed in any order and any of steps (a)-(d) may be optionally repeated.

In the compositions and methods of this disclosure, a hydrogel polymer of interest—or individual components thereof—may be delivered to a below-ground target zone without disrupting the surface. Alternatively, a hydrogel polymer of interest—or individual components thereof—may be applied to a below-ground target zone after a soil surface has been disrupted.

### BRIEF DESCRIPTION OF THE FIGURES

Non-limiting embodiments of the present disclosure will now be described by way of example only and with reference to the following figures: FIG. 1 depicts percentages of field capacity for rootzone moisture retention of study data from Example 1.

FIG. 2 depicts rootzone volumetric water content of study data from Example 2.

FIGS. 3A-D depict sample soil moisture data measured by time-domain reflectometry on assessment days 5 (FIG. 3A), 9 (FIG. 3B), 13 (FIG. 3C), and 22 (FIG. 3D) from Example 2.

FIG. 4 depicts visual assessment of turf quality from Example 3.

FIGS. 5A-B depict localized dry spot in percent of plot from Example 4.

### DETAILED DESCRIPTION OF THE INVENTION

According to the disclosure, a process for improving retention of plant-available soil water comprises, consists essentially of, or consists of:
a. applying a composition comprising hydrogel-forming components to a soil surface or an above-soil plant part and
b. watering the soil surface or above-soil plant part,
   wherein, after (b), the hydrogel-forming components form a hydrogel in situ in a targeted area, optionally a root zone of a plant.

Hydrogel-forming components according to the disclosure may also be applied stepwise. According to the disclosure, a process for improving retention of plant-available soil water may also comprise, consist essentially of, or consist of:
a. applying a first hydrogel-forming component to a soil surface or an above-soil plant part,
b. applying a second hydrogel-forming component to a soil surface or an above-soil plant part,
c. optionally applying one or more additional components to a soil surface or to an above-soil plant part, and
d. watering the soil surface or above-soil plant part,
   wherein the first and second hydrogel-forming components independently comprise, consist essentially of, or consist of one or more backbone moieties or one or more crosslinking moieties,
   wherein, if the first hydrogel-forming component comprises, consists essentially of, or consists of one or more backbone moieties, the second hydrogel-forming component comprises, consists essentially of, or consists of one or more crosslinking moieties,
   wherein, if the first hydrogel-forming component comprises, consists essentially of, or consists of one or more crosslinking moieties, the second hydrogel-forming component comprises, consists essentially of, or consists of one or more backbone moieties, and
   wherein steps (a)-(d) may be performed in any order and any of steps (a)-(d) may be optionally repeated.

For example, a first additional component may be applied to a soil surface or to an above-soil plant part; the soil surface or above-soil plant part may be watered; a first hydrogel-forming component may be applied to the soil surface or the above-soil plant part; a second additional component may be applied to the soil surface or to the above-soil plant part; the soil surface or above-soil plant part may be watered; a second hydrogel-forming component may be applied to the soil surface or the above-soil plant part; and the soil surface or above-soil plant part may be watered.

In the compositions and methods of this disclosure, a hydrogel polymer of interest—or individual components thereof—may be delivered to a below-ground target zone without disrupting the surface. Alternatively, a hydrogel polymer of interest—or individual components thereof—may be applied to a below-ground target zone after a soil surface has been disrupted.

In an embodiment, the composition further comprises one or more adjuvants. In an embodiment, the one or more adjuvants comprise wetting agents, soil surfactants, or mixtures thereof.

In an embodiment, the composition further comprises one or more biocides, antifoam, pesticides, insecticides, herbicides, and/or fungicides.

In an embodiment, the one or more additional components comprise one or more adjuvants, biocides, pesticides, insecticides, herbicides, and/or fungicides. In an embodiment, the one or more adjuvants comprise wetting agents, soil surfactants, or mixtures thereof.

### Backbone and Crosslinking Moieties

Non-limiting examples for suitable polymers for the synthesis of hydrogels are chemically or physically crosslinked functionalized or non-functionalized polyalkyloxy-based polymers like poly(propylene glycol) or poly(ethylene glycol), dextran, chitosan, hyaluronic acid and derivatives, alginate, xylan, mannan, carrageenan, agarose, cellulose, starch, hydroxyethyl starch (HES) and other carbohydrate-based polymers, poly(vinyl alcohols), poly(oxazolines), poly(anhydrides), poly(ortho esters), poly(carbonates), poly(urethanes), poly(acrylic acids), poly(acrylamides) such as poly(hydroxypropylmethacrylamide) (HMPA), poly(acrylates), poly(methacrylates) like poly(hydroxyethylmethacrylate), poly(organophosphazenes), poly(siloxanes), poly(vinylpyrrolidone), poly(cyanoacrylates), poly(esters) such as poly(lactic acid) or poly(glycolic acids), poly(iminocarbonates), poly(amino acids) such as poly(glutamic acid) or poly lysine, collagen, gelatin, copolymers, grafted copolymers, cross-linked polymers, hydrogels, and block copolymers from the above listed polymers.

These polymers may serve as backbone moieties or crosslinking moieties. In addition to oligomeric or polymeric crosslinking moieties, low-molecular crosslinking moieties may be used, especially when hydrophilic high-molecular weight backbone moieties are used for the hydrogel formation.

Suitable physical or chemical crosslinking methods are known to the person skilled in the art and are described in W. E. Hennink and C. F. van Nostrum, Adv. Drug Del. Rev. 2002, 54, 13-36, which is incorporated by reference.

In an embodiment, the backbone moiety comprises, consists essentially of, or consists of polyvinyl alcohol (PVA).

There are a variety of PVAs which differ in molecular weight, degree of polymerization, and degree of hydrolysis. The difference in molecular weight is also commonly expressed in terms of solution viscosity in the industry. According to the disclosure, a backbone moiety comprising, consisting essentially of, or consisting of PVA may be of any general molecular weight, degree of polymerization, and degree of hydrolysis acceptable to one of skill in the art. In an embodiment, degrees of polymerization of PVA may be in a range of from about 150 to about 2200. In an embodiment, viscosity of a 4% w/w solution of PVA at 20° C. may be in a range of from about 3 to about 72 cps (determined by Brookfield synchronized-motor rotary type). In an embodiment, the degree of hydrolysis of PVA may be in a range of from about 70% to about 99.8%. In an embodiment, the average molecular weight range of PVA may be in a range of from about 13,000 to about 186,000.

In an embodiment, the PVA of the instant disclosure has a moderate degree of polymerization and degree of hydrolysis, for example, a PVA with a viscosity of 5 cps of the 4% aqueous solution at 20° C. with 88% degree of hydrolysis.

In an embodiment, the PVA may be modified, such as a PVA alternative containing carboxylate side chains.

Crosslinking moieties, or crosslinkers, are compounds with two or more polymerizable functional groups. Examples of crosslinkers include aliphatic dialdehydes such as glutaraldehyde and glyoxal, aliphatic dicarboxylic acids such as maleic acid, fumaric acid and sulfosuccinic acid, aromatic dicarboxylic acids such as phthalic acid and terephthalic acid, aliphatic tricarboxylic acids such as citric acid and aconitic acid, aliphatic diisocyanate such as hexamethylene diisocynate, and non-linear crosslinkers such as boric acid and other borate-containing compounds, combinations thereof and the like.

Other crosslinkers include, but are not limited to, examples such as TEGDMA (tetraethyleneglycol dimethacrylate), TrEGDMA (triethyleneglycol dimethacrylate), EGDMA (ethyleneglycol dimethacylate) and combinations thereof.

In an embodiment, the crosslinker is a borate-containing compound. In an embodiment, the borate-containing compound comprises, consists essentially of, or consists of potassium borate, potassium tetraborate, potassium perborate, sodium borate, sodium tetraborate, or sodium perborate.

In an embodiment, the borate-containing compound comprises, consists essentially of, or consists of potassium borate. Potassium borate may be obtained, for example, by reacting potassium hydroxide with boric acid in aqueous solution or by dissolving potassium borate in water. The combination of polyvinyl alcohol and potassium borate provides good efficiency and offers great plant safety and is environmentally friendly.

In another embodiment, the borate-containing compound comprises, consists essentially of, or consists of potassium tetraborate tetrahydrate. In another embodiment, the borate-containing compound comprises other counter-cations such as, for example, sodium (i.e., sodium borate, sodium tetraborate, sodium perborate, borax, etc.).

### Adjuvants

In an embodiment, the composition of the disclosure further comprises, consists essentially of, or consists of one or more adjuvants. Alternatively, the at least one additional component comprises, consists essentially of, or consist of one or more adjuvants. In an embodiment, the one or more adjuvants comprise a soil surfactant, a wetting agent, or a mixture thereof.

In an embodiment, the soil surfactant can be of the emulsifying or wetting type and can be cationic, anionic or non-ionic.

In another embodiment, the soil surfactant is preferred to be anionic or non-ionic.

Examples of anionic soil surfactant include, but are not limited to, salts of polyacrylic or lignosulfonic acids; salts of phenosulfonic or naphthalenesulfonic acids; salts or ester-salts of sulfosuccinic acids; or phosphate esters such as polyethoxylated phosphate esters.

Examples of nonionic soil surfactants include, but are not limited to, polycondensates of ethylene oxide with fatty alcohols or fatty acids or fatty amines or substituted phenols (particularly alkylphenols or arylphenols); block co-polymers including both straight block co-polymers and reverse block co-polymers, as well as modified methyl capped block co-polymers; alkyl polyglucoside surfactants; humic substance redistribution molecules and multibranched regenerating wetting agents such as random copolymers and star polymeric surfactants. Blended non-ionic soil surfactants, such as, for example, those containing both alkyl polyglucoside and block copolymer, are also contemplated as examples of nonionic soil surfactants. In an embodiment, the surfactant comprises a polyoxyethylene, polyoxypropylene block polymer. In an embodiment, the surfactant comprises a compound of formula (I)

HO(C₂D₄O)ₓ(C₃H₆O)_{y}(C₂H₄O)_{z}H (I),

wherein y is at least 15, x and z are approximately equal, and polyoxyethylene content is 10 to 80% of total weight of the compound. In an embodiment, the surfactant comprises a compound of formula (I) wherein x is 8, y is 30, and z is 8.

Surfactants can be used in some applications to facilitate the infiltration of water into soil, for example, where there is a water-repellant or hydrophobic soil layer or layers. In such an instance, water tends to flow laterally above the hydrophobic layer and then is redirected to drainage channels (e.g., preferential flow channels), which leads the water through the hydrophobic layer. This effect, also known as distribution flow or fingered flow, decreases uniform wetting beneath the hydrophobic layer, but can be counteracted through use of surfactants as surface active agents. When applying a composition of the present disclosure to soil with hydrophobic surface or hydrophobic pockets, adjuvants contained in said composition facilitate both entry into targeted rootzone and moieties and delivery to localized dry spots.

### Root Zone

The root zone of a plant generally varies, among other factors, depending on plants, soil type, soil history, cultivation activity, and the like, but is typically less than about 20 feet below the soil surface. In one embodiment, the depth at which the hydrogel-forming components of the present disclosure form a hydrogel in situ is no greater than 20 feet below the soil surface, more typically within 1 to 6 feet.

### Plant or Plant Part

By “plant” is intended whole plants, plant organs (e.g., leaves, stems, roots, etc.), seeds, plant cells, propagules, embryos and progeny of the same. Plant cells can be differentiated or undifferentiated (e.g., callus, suspension culture cells, protoplast, leaf cells, root cells, phloem cells, pollen). “Plant parts” shall be understood to mean all parts and organs of the plants above and below ground, such as shoot, leaf, flower, and root, examples given being leaves, needles, stalks, stems, flowers, fruit bodies, fruits and seeds, and also roots, tubers and rhizomes.

### Plants Treated

Compositions, components, and methods presented herein can be applied to plants used in horticulture, plantations, urban forests, lawns, landscapes, golf courses, sports fields, parks, and commercial areas.

### Turfgrass

The present invention can be practiced on all grasses, including those used for lawns or other ornamental purposes, such as turfgrass, and those used as food or to produce grain for human or animal consumption. Some grasses, such as ryegrasses, can be used both for food and for aesthetic purposes.

In an embodiment, the present compositions, components, and methods are applied to turfgrasses, which are typically characterized as cool season turfgrasses and warm season turfgrasses. The present compositions, components, and methods can be applied to either warm or cool season turfgrasses.

Turf species that can be used include creeping bentgrass, colonial bentgrass, annual bluegrass, other Poa species of grasses, Bermudagrass, ryegrass, and other common grasses of golf courses, sport fields, commercial recreation areas, and sod farms.

Examples of cool season turfgrasses are bluegrasses (Poa spp.), such as Kentucky bluegrass (Poa pratensis L.), rough bluegrass (Poa trivialis L.), Canada bluegrass (Poa compressa L.), annual bluegrass (Poa annua L.), upland bluegrass (Poa glaucantha Gaudin), wood bluegrass (Poa nemoralis L.), and bulbous bluegrass (Poa bulbosa L.); the bentgrasses and redtop (Agrostis spp.), such as creeping bentgrass (Agrostis palustris Huds.), colonial bentgrass (Agrostis tenuis Sibth.), velvet bentgrass (Agrostis canina L.), South German Mixed Bentgrass (Agrostis spp. including Agrostis tenius Sibth., Agrostis canina L., and Agrostis palustris Huds.), and redtop (Agrostis alba L.); the fescues (Festucu spp.), such as red fescue (Festuca rubra L. spp. rubra), creeping fescue (Festuca rubra L.), chewings fescue (Festuca rubra commutata Gaud.), sheep fescue (Festuca ovina L.), hard fescue (Festuca longifolia Thuill.), hair fescue (Festucu capillata Lam.), tall fescue (Festuca arundinacea Schreb.), meadow fescue (Festuca elanor L.); the ryegrasses (Lolium spp.), such as annual ryegrass (Lolium multiflorum Lam.), perennial ryegrass (Lolium perenne L.), Italian ryegrass (Lolium multiflorum Lam.); and the wheatgrasses (Agropyron spp.), such as fairway wheatgrass (Agropyron cristatum (L.) Gaertn.), crested wheatgrass (Agropyron desertorum (Fisch.) Schult.), and western wheatgrass (Agropyron smithii Rydb.). Other cool season turfgrasses include beachgrass (Ammophila breviligulata Fern.), smooth bromegrass (Bromus inermis Leyss.), cattails such as Timothy (Phleum pratense L.), sand cattail (Phleum subulatum L.), orchardgrass (Dactylis glomerata L.), weeping alkaligrass (Puccinellia distans (L.) Parl.) and crested dog's-tail (Cynosurus cristatus L.).

Examples of warm season turfgrasses include Bermudagrass (Cynodon spp. L. C. Rich), zoysiagrass (Zoysia spp. Willd.), St. Augustine grass (Stenotaphrum secundatum Walt Kuntze), centipedegrass (Eremochloa ophiuroides Munro Hack.), carpetgrass (Axonopus affinis Chase), bahiagrass (Paspalum notatum Flugge), Kikuyugrass (Pennisetum clandestinum Hochst. ex Chiov.), buffalo grass (Buchloe dactyloids (Nutt.) Engelm.), blue gramma (Bouteloua gracilis (H.B.K.) Lag. ex Griffiths), seashore Paspalum (Paspalum vaginatum Swartz) and sideoats grama (Bouteloua curtipendula (Michx. Torr.).

The described compositions and components may be applied to healthy or diseased turfs. Preventative application to turf before conditions of reduced water irrigation may be helpful in reducing water stress and improving turf quality, density, color, and/or plant cell turgidity. Without being limited by any particular theory, application of the present compositions and components to turf may also be helpful in treating one or more turf diseases, such as dollar spot, brown patch, anthracnose, gray leaf spot, and diseases of golf courses, sport fields, and sod farms. The described compositions and components may also be helpful in improving turf quality, density, color, and/or plant cell turgidity during reduced water conditions in the summer.

### Application Rates

When using the present compositions and components, application rates can be varied within a relatively wide range, depending on the kind of application. Application rates of the compositions are generally between about 0.1 and about 50,000 g/ha. In an embodiment, application rates of the compositions may be between about 0.5 and about 20,000 g/ha.

Furthermore, embodiments of the composition may be applied at about 1 to about 100 gallons per acre, or about 1 to about 50 gallons per acre, or about 1 to about 10 gallons per acre, or about 1 to about 5 gallons per acre, or about 1 to about 4 gallons per acre, or about 1 to about 3 gallons per acre, or about 2 to about 10 gallons per acre, or about 2 to about 5 gallons per acre, or about 2 to about 4 gallons per acre, or about 2 to about 3 gallons per acre.

In other embodiments, the composition may be applied at about 1 to about 100 gallons/1000 sq. ft., or about 1 to about 50 gallons/1000 sq. ft., or about 1 to about 10 gallons/1000 sq. ft., or about 1 to about 5 gallons/1000 sq. ft., or about 1 to about 2 gallons/1000 sq. ft.

In other embodiments, the composition may be applied at about 0.1 to about 100 oz./1000 sq. ft., or about 1 to about 50 oz./1000 sq. ft., or about 1 to about 10 oz./1000 sq. ft., or about 1 to about 6 oz./1000 sq. ft.

### Composition Formulation

According to the disclosure, the backbone and the crosslinker may be combined at various concentrations in an aqueous or dry formulation. One or more adjuvants are optionally added to the formulation.

In an embodiment, the backbone and the crosslinker may be applied separately (e.g., stepwise) and not as a composition.

In an embodiment, a ratio, by weight, of the backbone to the crosslinker is in a range of from about 20:1 to about 1:10. In an embodiment, a ratio, by weight, of the backbone is in a range of from about 15:1 to about 1:5; or in a range of from about 12:1 to about 1:2; or in a range of from about 10:1 to about 1:1. In an embodiment, a ratio, by weight, of the backbone to the crosslinker is about 12:1, about 11:1, 10:1, about 9:1, about 8:1, about 7:1, about 6:1, about 5:1, about 4:1, about 3:1, about 2:1; about 1.5:1; about 1:1; about 0.5:1; about 1:0.5, about 1:1.5, about 1:2, about 1:3, about 1:4, about 1:5, about 1:6, about 1:7, about 1:8, about 1:9, about 1:10, about 1:11, or about 1:12.

The aqueous or dry formulation comprising the hydrogel-forming components (i.e., the backbone and crosslinker, and optionally one or more surfactants), is topically applied, optionally by spraying, to soil surface or above-soil plant parts, and watered into the rootzone. The components of the disclosure migrate to a targeted area, optionally a root zone of a plant.

In an embodiment, a composition comprising the hydrogel-forming components, or individual hydrogel-components and one or more optional additional components may be applied to soil that has been disrupted. In an embodiment, the composition or individual components may be applied directly the root zone of a plant.

After a triggering event, such as, for example an increase in concentration of the backbone and the crosslinker as a result of water removal (e.g., leaching, evaporation, transpiration, etc.), crosslinking between the backbone and the crosslinker occurs, resulting in a hydrogel. (Besides a change in concentration, other triggering events include, but are not limited to, changes in pH value, temperature, surface properties, radiation, microenvironment parameters, and other physical-chemical properties from either soil or external sources.) In an embodiment, the resulting hydrogel can absorb more than about 10 times its original volume of water. In other embodiments, the resulting hydrogel can absorb more than between about 10 to about 100 times its original volume of water.

When present, optionally added surfactants facilitate entry of other components into soil profile and correct soil hydrophobicity pockets within the soil.

In an embodiment, application and placement of a liquid form of the hydrogel forming components into the rootzone or soil surface using, for example, spraying equipment, spreading/broadcasting equipment, or through irrigation water (e.g., irrigation line injection), occur stepwise. In another embodiment, application and placement occur simultaneously. In situ formation of polymers (hydrogels) occurs after application and placement.

In another embodiment, the backbone moiety, crosslinking moiety, and optional adjuvant(s) are prepared in and applied as a dry formulation.

It is apparent that embodiments other than those expressly described herein come within the spirit and scope of the present claims. Accordingly, the present invention is not defined by the above description, but is to be accorded the full scope of the claims so as to embrace any and all equivalent compositions and methods.

### EXAMPLES

Non-limiting examples according to the present disclosure are described herein.

Example 1: Constructed rootzone column study in controlled environment showing delayed soil moisture depletion in columns treated with PVA and borate based in-situ crosslinked hydrogel.

Treatments in comparison included an untreated check, a soil surfactant check (alkylated EO/PO block copolymer) at use rate of 19 kg/ha×3 applications, and a PVA and borate based in-situ crosslinked hydrogel at use rate of 20 kg/ha×3 applications. All treatments were surface applied with compressed air operated standard spraying nozzles and were lightly watered into soil profile post application. Soil moisture was determined using precise gravimetric method. Soil moisture of constructed columns at field capacity (saturated water content minus gravitational water content) is used as the benchmark of optimal soil moisture status. Study design was randomized complete block with 4 replications.

During the simulated soil drying process, PVA and borate based in-situ crosslinked hydrogel treated rootzone showed delayed moisture depletion under this imposed high evapotranspiration condition (e.g., vapor pressure deficit near or greater than 2 kPa). This observed benefit was particularly prominent during the middle phase of soil moisture depletion where foliage wilting typically occurs. Upon further drying, withheld soil moisture was eventually released. Study data is illustrated in FIG. 1, which features percentages of field capacity for rootzone moisture retention.

Example 2: Deficit irrigation study on an established ‘Champion’ ultradwarf Bermudagrass putting green. Rootzone water content at 2-inch below surface was monitored over a 2-month period in summer in a transition zone climate (central North Carolina). Treatments in comparison included an untreated check, a soil surfactant check (alkylated EO/PO block copolymer) at use rate of 9.5 kg/ha at 14-day interval, and a PVA and borate based in-situ crosslinked hydrogel at use rate of 20 kg/ha at 14-day interval. All treatments were surface applied with compressed CO₂-operated standard spraying equipment. Field plots were given 1/10 inch of irrigation water after each application event. Soil moisture was quantitatively determined as volumetric water content using as a time-domain reflectometry (TDR) based soil moisture probe. Design was randomized complete block with 4 replications.

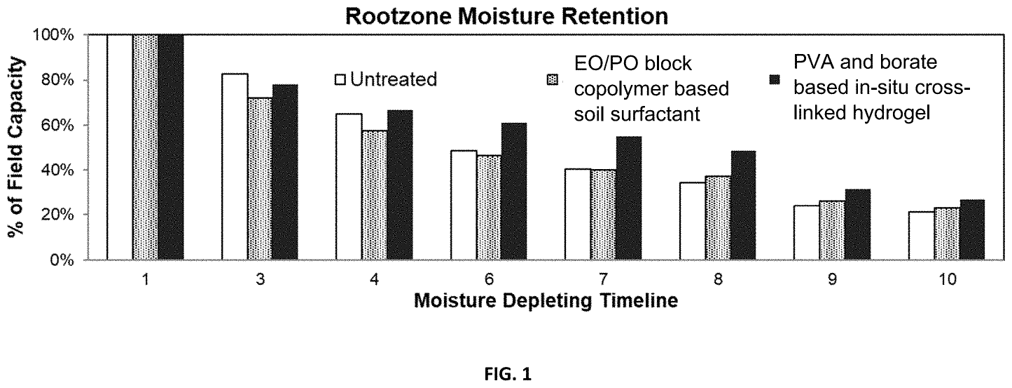

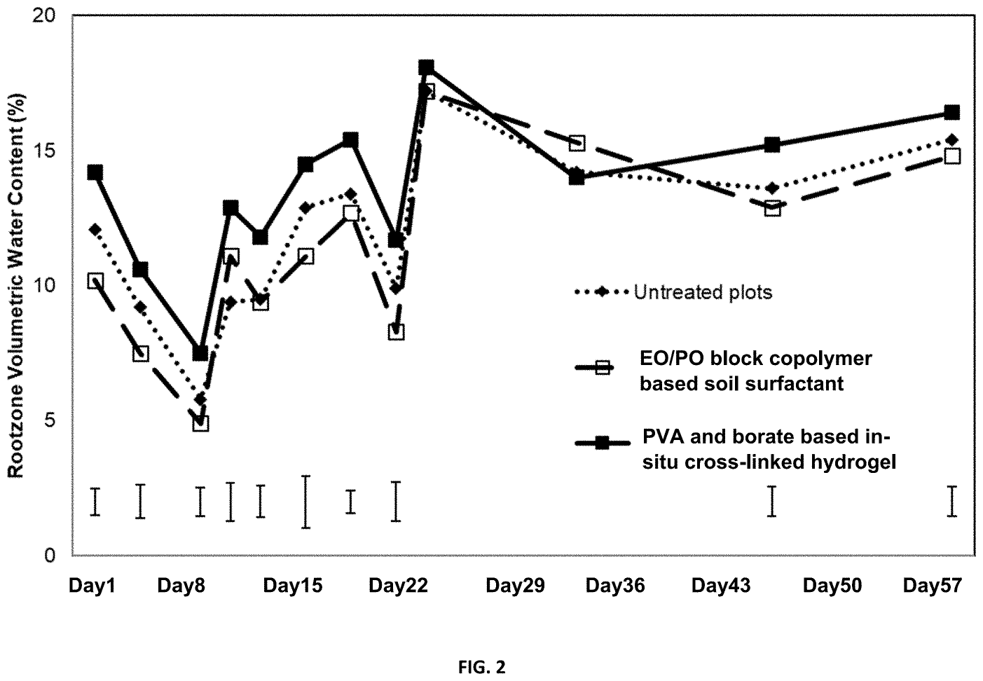

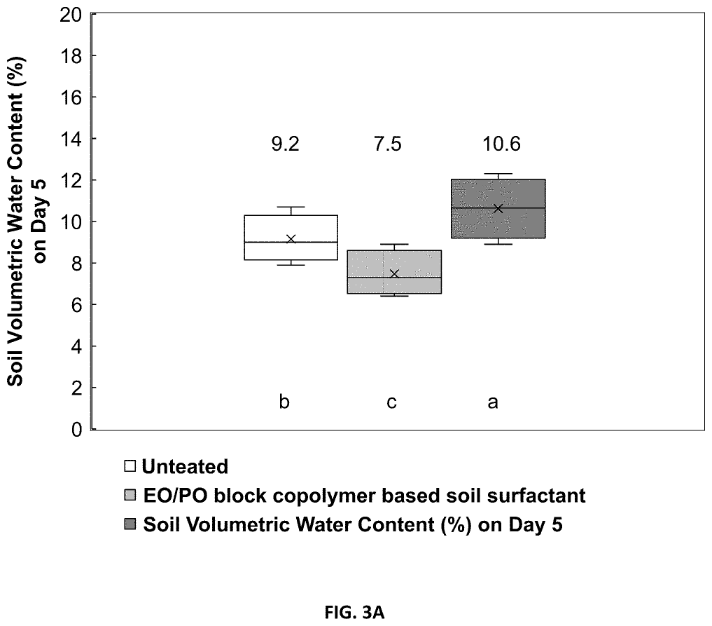

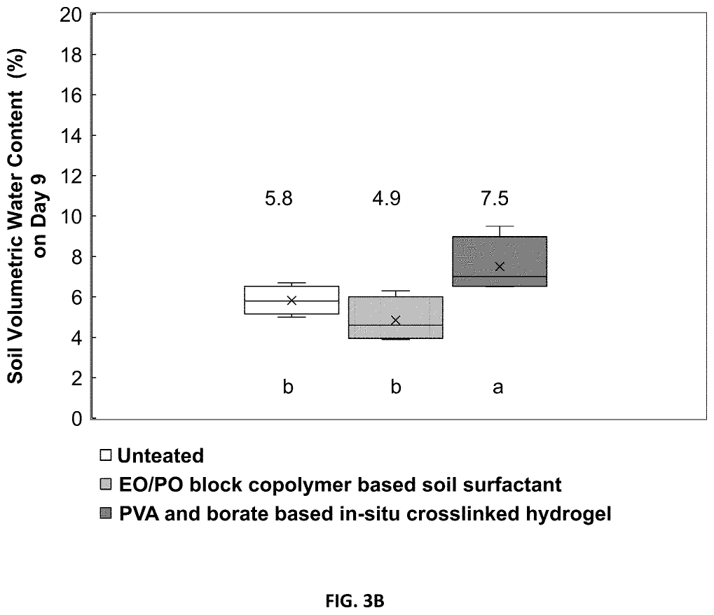

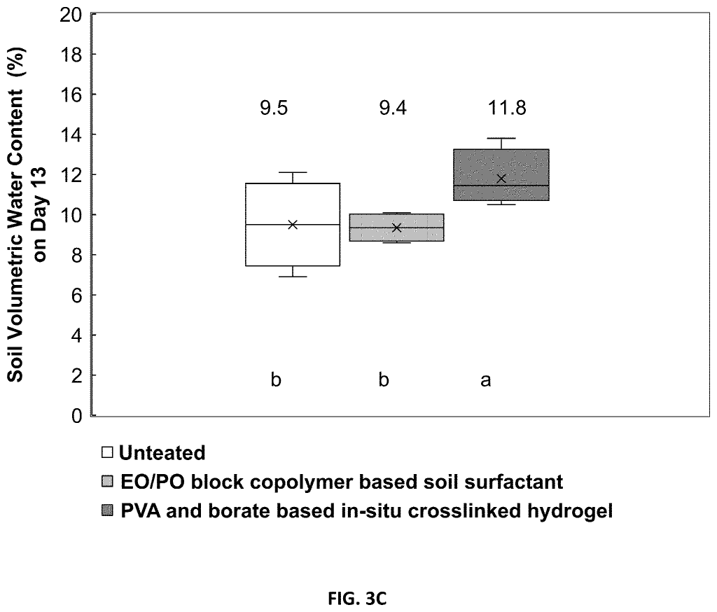

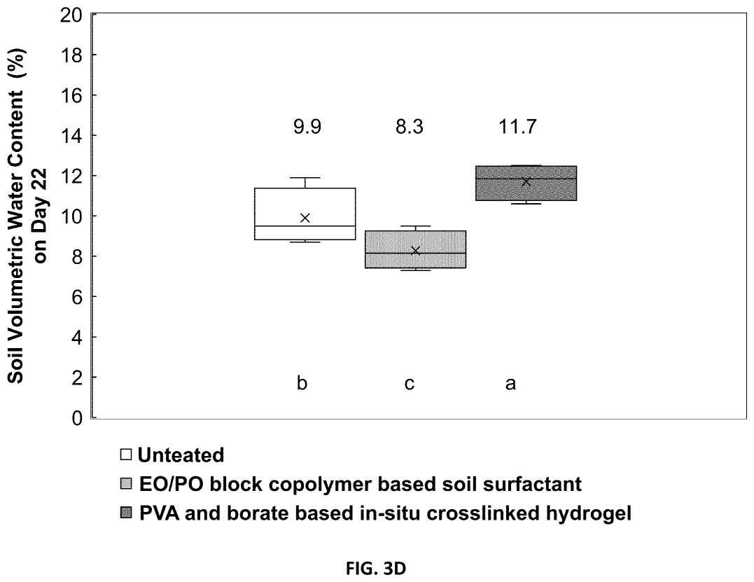

Over a wide range of soil water content observed in trial, PVA and borate based in-situ crosslinked hydrogel treated plots maintained higher rootzone moisture especially during phase of soil drying as a result of deficit irrigation. This benefit was particularly prominent when soil moisture declined close to or below ˜10% volumetric water content (Study data illustrated in FIG. 2, which depicts rootzone volumetric water content). This is approximately the critical soil moisture level, near which wilting very likely occurs at this study site. Better maintained soil moisture during soil drying helps prevent over-watering, delays wilting, and reduces hand-watering events. Sample soil moisture data measured by time-domain reflectometry on a few assessment dates is illustrated in FIGS. 3A-D.

Example 3. Summer stress and deficit irrigation study on an established ‘Proclamation’ creeping bentgrass research putting green. Study was conducted for 2-month period in a transition zone climate (central North Carolina). Treatments in comparison included an untreated check, a soil surfactant check (alkylated EO/PO block copolymer) at use rate of 19 kg/ha at 28-day interval, and a PVA and borate based in-situ crosslinked hydrogel at use rate of 20 kg/ha at 14-day interval. All treatments were surface applied with compressed CO₂-operated standard spraying equipment. Field plots were given 2/10 inch of irrigation water after each application event. Design was randomized complete block with 4 replications.

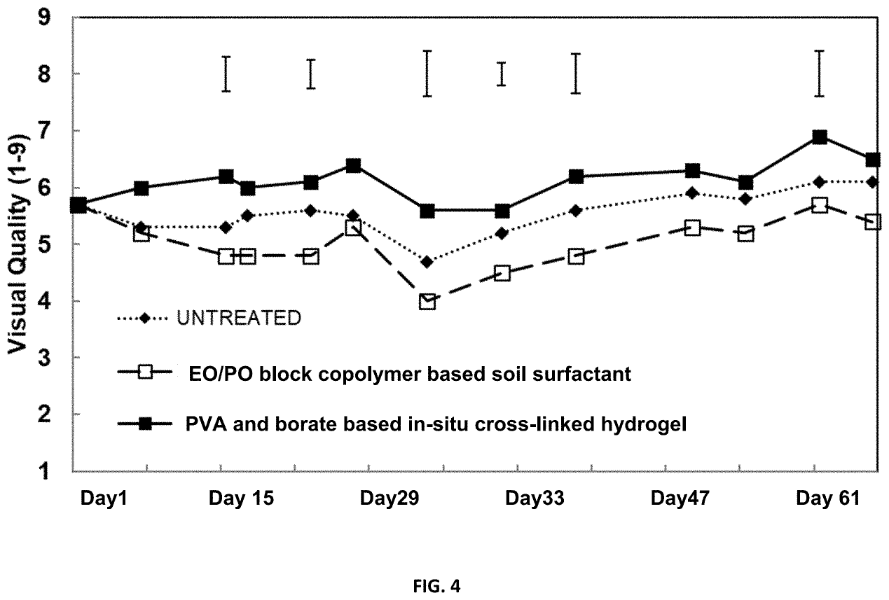

With natural summer stress and a deficit irrigation at ˜80% of reference evapotranspiration, PVA and borate based in-situ crosslinked hydrogel treated plots maintained better overall turf quality throughout trial duration (Study data illustrated in FIG. 4). Turf quality visual rating is an industry standard assessment method to reflect visual differences in color, density, uniformity, disease incidence, environmental stress or other factors (see National Turfgrass Evaluation Program (NTEP), http://www.ntep.org/reports/ratings.htm#quality). It takes into account the aesthetic and functional aspects of the turf. Most visual ratings are based on a 1 to 9 rating scale.

Quality is based on 9 being outstanding or ideal turf and 1 being poorest or dead. A rating of 6 or above is generally considered acceptable. A quality rating value of 9 is reserved for a perfect or ideal grass, but it also can reflect an absolutely outstanding treatment plot. Observation was also made that soil surfactant check (alkylated EO/PO block copolymer) treatment resulted in short-term (a few days) discoloration following application while no such adverse effect was associated with PVA and borate based in-situ crosslinked hydrogel.

Example 4. Summer stress and deficit irrigation study on an established ‘L-93’ creeping bentgrass research putting green with constructed rootzone per USGA-specification. Study was conducted for 3-month period in a transition zone climate (central Missouri, USA). Treatments in comparison included an untreated check, a soil surfactant check (alkylated EO/PO block copolymer) at use rate of 19 kg/ha at 28-day interval (EOPO-28) and use rate of 9.5 kg/ha at 14-day interval (EOPO-14), PVA and borate based in-situ crosslinked hydrogel in two formulations (F1 & F2) at use rate of 10 kg/ha every 28-day (F1-28 & F2-28) and use rate of 10 kg/ha every 14-day (F1-14 & F2-14). All treatments were surface applied with compressed CO₂-operated standard spraying equipment. Field plots were given 2.5 mm depth of irrigation water after each application event. Design was randomized complete block with 4 replications.

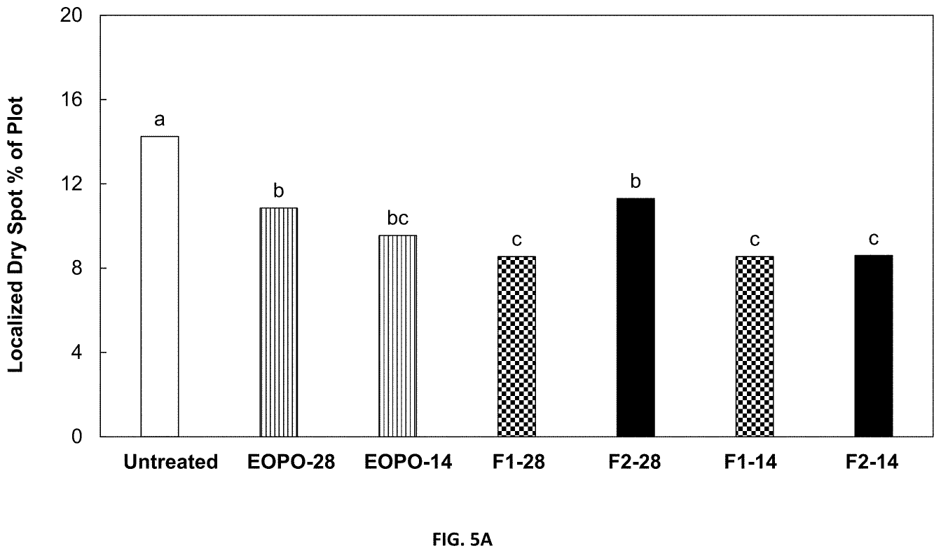

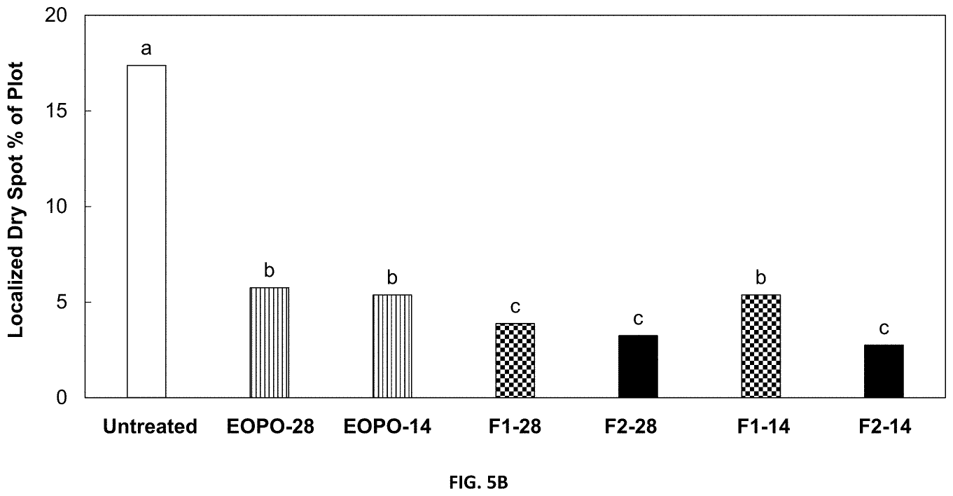

With natural summer stress and imposed rootzone moisture deficit (alternative optimal and 60% of reference evapotranspiration every 14-day), PVA and borate based in-situ crosslinked hydrogel treated plots significantly reduced occurrence of localized dry spots within treated plots throughout trial duration (FIG. 5A: first 30-day after treatments started; FIG. 5B: 70- to 80-day after treatments started). Observed benefit associated with PVA and borate based in-situ crosslinked hydrogel was evident in both formulations (F1 & F2), both application regimes (14-day & 28-day at 10 kg/ha), and in both timings (FIG. 5A: moderate stress; FIG. 5B: severe stress).

1. A process for improving retention of plant-available soil water comprising
a. applying a composition comprising hydrogel-forming components to a soil surface or an above-soil plant part and
b. watering the soil surface or above-soil plant part,
wherein, after (b), the hydrogel-forming components form a hydrogel in situ in a targeted area, optionally a root zone of a plant.

2. The process according to claim 1, wherein the hydrogel-forming components comprise one or more backbone moieties, one or more crosslinking moieties, and, optionally, one or more adjuvants.

3. A process for improving retention of plant-available soil water comprising:
a. applying a first hydrogel-forming component to a soil surface or an above-soil plant part,
b. applying a second hydrogel-forming component to a soil surface or an above-soil plant part,
c. optionally applying one or more additional components to a soil surface or to an above-soil plant part, and
d. watering the soil surface or above-soil plant part,
wherein the first and second hydrogel-forming components independently comprise one or more backbone moieties or one or more crosslinking moieties,
wherein, if the first hydrogel-forming component comprises one or more backbone moieties, the second hydrogel-forming component comprises one or more crosslinking moieties,
wherein, if the first hydrogel-forming component comprises one or more crosslinking moieties, the second hydrogel-forming component comprises one or more backbone moieties, and
wherein steps (a)-(d) may be performed in any order and any of steps (a)-(d) may be optionally repeated.

4. The process according to claim 2, wherein the one or more backbone moieties comprise polyvinyl alcohol, and wherein the one or more crosslinking moieties comprise a borate-containing compound.

5. The process according to claim 1, wherein in (a), the hydrogel-forming components are present in an aqueous formulation or in a dry formulation.

6. The process according to claim 4, wherein the borate-containing compound comprises potassium borate, potassium tetraborate, potassium perborate, sodium borate, sodium tetraborate, or sodium perborate.

7. The process according to claim 4, wherein the borate-containing compound comprises potassium borate.

8. The process according to claim 1, wherein one or more adjuvants is present and comprises a soil surfactant, a wetting agent, or a mixture thereof.

9. The process according to claim 8, wherein a soil surfactant is present and comprises an ethylene-oxide/propylene oxide (EO/PO) copolymer.

10. The process according to claim 8, wherein a soil surfactant is present and comprises a nonionic triblock copolymer.

11. The process according to claim 8, wherein a soil surfactant is present and comprises a polyoxyethylene, polyoxypropylene block polymer.

12. The process according to claim 8, wherein a soil surfactant is present and comprises a compound of formula (I),
HO(C₂H₄O)ₓ(C₃H₆O)_{y}(C₂H₄O)_{z}H (I),
wherein y is at least 15, x and z are approximately equal, and polyoxyethylene content is 10 to 80% of total weight of the compound.

13. The process according to claim 12, wherein x is 8, y is 30, and z is 8.

14. The process according to claim 1, wherein, after (b), the hydrogel-forming components form a hydrogel in situ in a root zone of a plant.

15. The process according to claim 14, wherein the plant is turfgrass.
